(19) United States
(12) Patent Application Publication
(10) Pub. No.: US 2004/0098449 A1
(43) Pub. Date: May 20, 2004

(54) System and method for disseminating information over a communication network according to predefined consumer profiles

(76) Inventors: Shai Bar-Lavi, Kings Point, NY (US); Robert Hopwood, Trumbull, CT (US); Shlomo Shur, Fairfield, CT (US)

Correspondence Address: Frank Chau, F. Chau & Associates, LLC, Suite 501, 1900 Hempstead Turnpike, East Meadow, NY, 11554, US

(21) Appl. No.: 10/712,878

(22) Filed: Nov. 13, 2003

Related U.S. Application Data
(62) Division of application No. 09/588,768, filed on Jun. 6, 2000.
(60) Provisional application No. 60/177,402, filed on Jan. 20, 2000.

(51) Int. Cl. G06F 15/16

(52) U.S. Cl. 709/202

(57) ABSTRACT

A system and method for distributing information to interested users according to predefined preferences over the Internet. The invention provides improved techniques for reaching potential recipients, for simplifying the initial response by interested individuals, and for facilitating the gathering and organizing of information from those individuals.

The communication structure includes one or more servers and a plurality of dedicated client-side communication modules (“comm modules”). The servers store multimedia entertainment, advertising, or other information content and as well as profile information for the users of the comm modules. The stored information is organized according to the user profiles and is selectively made available for downloading on demand.

The comm modules are preferably made available for installation on the client-side computers by distribution as an adjunct to the information, advertising or entertainment content of a multimedia product such as a CDROM or DVD. Profile information is developed the first time a user goes on line after installing the software. The comm module displays a small icon on the user's desktop which changes state whenever there is new information on the server corresponding to the user's profile. Users may then access the information at their convenience.

The comm module includes a mini Web browser programmed for display of full-featured Web pages. It is compatible with operating systems commonly in use, and is runtime configurable and upgradable via server configuration messages. When the user goes online, the comm module connects directly to a routing server at a predetermined Internet address.

### BACKGROUND OF THE INVENTION

1) Technical Field

The present invention relates to information transfer and gathering, and more particularly to a system and method to facilitate providing content of interest, gathering user information and targeting of advertisements delivered to users over a communication network such as the Internet.

2) Discussion of the Related Art

Along with the recent growth of the Worldwide Web through the Internet, commerce conducted over the Internet (“e-commerce”) has experienced tremendous growth as well. The availability of products and services offered over the Internet seems unlimited and endless. However, numerous computer or web use participants are novices and so with the enormous amount of information available on the Internet, many who get online with the intention to conduct commerce such as electronic shopping, fail to close a transaction (or even start one) because of the inability to traverse the myriad of hyperlinks to find information on the product or service in mind. In view of this, companies advertise on popular servers, such as America Online, and on popular websites, such as Yahoo.com, in attempts to lure Internet users to view their products. Such advertising is random and untargeted and thus has had a limited rate of response.

It has long been known in advertising that the rate of response to ads increases when advertisements are targeted to the appropriate potential customer base, rather than simply broadcasting advertisements in general. For example, advertisements for office stationary supplies should not appear in fashion magazines, and vice versa. The ability to communicate selectively with and to store information about chosen recipients has given new effectiveness to the techniques of targeted or one-to-one marketing which have developed in recent years. To maximize the response rate, an advertiser therefore typically wishes to reach as many individuals in the advertiser's target group as possible, i.e., gathering of information from and about users and potential users, organizing that information for business and other purposes, and selectively disseminating information based on users' needs or interests.

One technique used to gather user interest information is through product registration cards as part of an online registration process in which the responder is asked to provide his or her E-mail address and to indicate if he or she wishes to receive further communication from advertisers. This approach to identifying potential recipients is somewhat random and untargeted. In addition, it is not as effective as might be desired in relation to those who spend limited time online, or for products which are primarily not used in conjunction with a personal computer.

Based on the information provided by the registrants, advertisements of like products are sent by electronic mail to the registrants. Alternatively, the recipients can be notified by E-mail to visit a Web site identified in the message at which both content of interest and advertising is presented. Sometimes a notification is transmitted which appears on the user's screen, either in the form of a “pop-up window” or icon.

All of these techniques have disadvantages. One such disadvantage is the variation in functionality and features of E-mail clients and Web browsers available on the recipients' computers. This can adversely affect the quality of the presentation and enjoyment of the experience for users who have older or less full-featured software. Similarly, pop-up windows can be annoying, and for those not accustomed to receiving and managing E-mail on a regular basis, inconvenient as well.

In another business model, much of the information disseminated on the Worldwide Web (the “Web”) is provided at no cost to the recipient. In that business model, the profit for the provider is typically derived from paid advertising of other enterprises delivered with the transmitted information. Providers offer advertisement in the form of streaming banners encouraging visitors interested in the subject matter to click or select the banner, thereby hyperlinking to the advertiser. In some instances, providers offer awards by way of credits or points to users who access or interact with site contents. For example, users are enticed to sign on or register with the provider with a chance of winning money or points. The points can then be used as credit toward purchases of goods or in exchange for travel bonuses, like airline mileage points. The provider itself may also utilize the transaction as a vehicle for promoting products or services of its own.

One class of potential recipients not well accessed by the above techniques are purchasers of music Compact Disks (“CD's”) or multimedia products such as Digital Versatile Disks (“DVD's”). Such individuals (usually adolescents or young adults) would enjoy having access to personal information about their favorite performers as well as concert schedules, announcements of new releases, etc., but if they are not regular users of online communication, there has not been a completely effective way to encourage them to make themselves known to the music companies and to use the Internet as a medium for enhancing their enjoyment of the products they have purchased. Encouraging such use of the Internet could produce benefits for consumers as well as information providers.

Moreover, after identifying those interested in a particular subject, an attempt is often made to extend their interests to related areas. An important E-business model which has arisen from the possibility is development and organization of demographic information from online users. The proprietor of this information may then provide the information to diverse sources of enhancement information likely to be of interest to specific users based on their profiles.

By way of example, an enterprise which develops a list of individuals interested in a particular country and western artist and in such music in general can sell access to this information to recording companies, which in turn can provide enhancement content such as announcements of impending releases of new recordings, concert schedule information, background information on the performers, recorded interviews, news of online chats with performers, etc. and advertising with respect to other products for distribution by the list proprietor.

Another known technique of gathering user behavioral characteristics is by tracking the traverse paths of users through the various sites on the Internet in a given online session. For example, when a user operates a web browser and is cookie-enabled, the user is identifiable and the information on particular websites and how often the sites are visited by the user can be gathered. From the collection of this information, a behavioral profile can be gathered on the user and such profile can be stored and possibly used for targeted advertising.

However, improving the ability to gather lists of receptive users in different categories is not enough, as existing models for dissemination of information (both content and advertising) are also not completely satisfactory. For example, the profile information gathered on users may often be outdated. Thus, like commercials that are repeated too often and become stale as a result, the audience likewise loses interest in repeated advertising targeted towards them based on outdated profile information. Also, the stored profile information lacks the ability to reflect the shifting interests of users.

Accordingly, a need exists for an apparatus and a method for 1) providing content of interests to targeted web users; 2) attracting user interaction with interactive content; 3) gathering user behavioral information on web users in real time; and 4) delivering profile-based information to the user.

### SUMMARY OF THE INVENTION

The present invention seeks to avoid the problems inherent in previously known practices and technology by providing improved techniques for reaching potential recipients, for simplifying the initial response by interested individuals, and for facilitating the gathering and organizing of marketing information from those individuals. The invention further seeks to provide cost-effective use of the profile information in marketing and advertising, to assure convenient access by recipients to information selected in accordance with their profiles, and to facilitate use of newly developed technology with developed technology without depending on recipients to take steps to upgrade their software.

An object of the present invention is to give content providers and retailers a highly efficient computer-based direct marketing mechanism that will allow them to provide their client base with personalized real-time information, products and services. The dynamic and real-time characteristics of Internet usage are captured in this invention, affording a non-intrusive yet highly targeted interactive direct marketing application. By utilizing this invention, companies marketing products and services will be able to provide their clientele with the kind of customized services they demand. This customized product thereby will establish a true one-to-one relationship with the user and create an environment that makes the end user more receptive to marketing messages and more likely to feel comfortable with the purchase of goods or services through the company's website.

A method and apparatus according to the present invention facilitates a unique and highly personalized delivery of information and marketing products and services to individuals through their computer desktops. The method includes embedding communication modules (“comm modules”) on a user's PC desktop, usually in the form of an icon, and provides pre-determined and highly targeted information to the user on a real time basis or whenever the user's PC is connected to the Internet.

A system according to the present invention includes a communication structure having one or more servers and a plurality of the comm modules installed on each of a plurality of remotely located personal computers. The computers and the servers are connected together over a communication network such as the Internet.

Stored on the servers is multimedia entertainment or other information content and advertising created by various content providers, as well as profile information of the users of the computers containing the comm modules. The information and advertising content stored on the servers is organized according to the user profiles and is selectively made available in accordance with the user profiles for viewing as Web pages.

One feature of the method according to the present invention is the preferred manner in which the comm modules are made available for installation on the client-side computers. Although it is possible within the scope of the invention for the comm modules to be downloaded from the server side of the system, they are preferably distributed as an adjunct to the information, advertising or entertainment content of a multimedia product such as a CD or DVD. These may be commercially produced entertainment products sold through normal commercial channels, or specially produced samplers or the like distributed as promotional items through mass mailings, in conjunction with the sale of related products, etc. The CD or DVD will feature some form of entertainment, such as a music or sports video, from a specific marketer, which will entice the recipient to load the program onto the PC. Such a sampler CD or DVD can also be distributed to concert goers or as part of a promotional program such as a giveaway in records stores, entertainment retailers and the like.

When the recipient plays the promotional CD or DVD, the comm module is installed on the recipient's computer as described below. During the initial booting process, the CD will install a Web interface, as well as audio and video players to the user's PC and then automatically open the Web interface page, connecting the user to the marketer's Web site. Concurrently, the CD installs the comm module as a desktop tray icon and gives the user the option to register with the marketer for additional products and services. With a completed registration application, the marketer now has a complete profile of the user stored on a main server.

In this way, the comm modules avoids the problems inherent in previously known practices and technology by providing corporate customers with significantly more efficient marketing techniques. Through the use of technology, client organizations are better able to reach potential recipients, to simplify the response by interested individuals, and to facilitate gathering marketing information from those interested individuals. In addition, the comm module aids in the development of individualized recipient profiles, and in the cost-effective use of the profile information in marketing and advertising. This marketing technology allows convenient access by recipients to information selected in accordance with their profiles, and facilitates use of newly developed techniques without depending on recipients to take steps to upgrade their software.

To reiterate, comm modules are automatically installed on the user's computer the first time the distribution disks are used for their main purpose. The comm module program is designed to run as part of the computer's start-up file, and when executed, it displays a small icon on the user's desktop. Thereafter, the first time a connection to the communication network is established, the user is automatically connected to the server-side of the system and is presented with a series of profile inquiry pages from which a profile of the user can be developed. Information contained on the distribution disk itself may also be included in the user's profile.

For example, if the original distribution disk contains performances by a particular artist or group, the profile might identify that artist or group and the particular type of music as the user's primary interest. However, the profile inquiry pages might also request information as to other artists, types of music and even other subjects about which the user would like to receive information.

If the distribution disk is produced by the list proprietor, including paid advertising as well as information content can defray the cost of production, or even be profitable in the first instance. This facilitates free distribution of an enormous number of comm modules and creation of a correspondingly large population of potential users. Even with a response rate typical for unsolicited advertising (e.g., about 2 percent), the list proprietor will be able to generate profiles for a large body of users likely to be receptive to targeted marketing efforts.

According to another feature of the invention, to alert the users to the availability of new information corresponding to their respective interest profiles, the desktop icon changes state based on messages from the server. The icon can flash, blink and emit audible tones alerting the user about the status of content availability. Users may then access the information at their convenience.

According to a further feature of the invention, the comm module includes a mini Web browser designed to display downloaded information in the form of Web pages coded in hypertext markup language (“HTML”). The design of the browser minimizes hard disk storage requirements, and imposes minimum demands on the system memory, while still providing all features necessary for communication with the servers and for display of full-featured Web pages. It is compatible with operating systems commonly in use, and is runtime configurable and upgradable via server configuration messages.

According to still another feature of the invention, when the user establishes a connection to the communication network, the comm module sends a message to a routing server at a predetermined Internet address. (We refer to this message as a “heartbeat” as it is preferably repeated at regular intervals.) This immediately informs the server that the user is online, and ready to receive messages. In addition, the server receives ‘real-time’ instantaneous feedback and information about the user, including every link within a website provided by the server the user clicks on, at the same time he does so. This feature distinguishes the present invention from the prior art teachings on various techniques of “push technology” such as Internet mailing lists, in that the present invention allows for contemporaneous real-time communication and exchange of information with the user. The real time and instantaneous nature of the feedback facilitates gathering of behavioral information ‘of the moment’ on the user.

Upon receipt of a new heartbeat message, the routing server sends a response that instructs the comm module where to send subsequent heartbeats. This allows distribution of users to different servers based on load, client version, or other criteria. A related feature of the invention is that each server can deliver the same routing message, allowing the real-time adjustment of server load, heartbeat frequency and other client behavior. It also permits convenient distribution of client behavior. It also permits convenient distribution of client software upgrades.

Another feature of the invention is a timed-response live link, where the user is rewarded for clicking on the link within a certain period of time. This link can be featured on a banner ad which hosts a quiz or trivia show, where the user is awarded a prize if he clicks on the link and answers within a certain amount of time, such as within 5 minutes.

According to yet another feature of the invention, the comm modules and the server system are designed to permit messaging between comm modules via the server. This creates the capability for chat or instant messaging between users having similar interests. The comm module alerts the user audibly or visually when a message from another comm module user is available in addition to the other content delivery functions.

Yet a further feature of this invention is programming the comm module to access a specific database on the server side and to provide user-identifying information without any intervention on the part of the user. This permits, for example, direct access to airline frequent flier mileage data, stock quotes, and (with sufficient security and privacy systems in place), private financial information simply by clicking on the associated icon.

As may be appreciated, a particular user might have a multiplicity of specific interests, each of which might be exploited using the techniques of the present invention. The result, however, could be the presence of numerous icons on the desktop, and undesirable desktop clutter. According to the present invention, this problem is dealt with by arranging the active icon so that clicking it opens a menu of separate channels, each having its own icon. Accessing these selectively provides the user with the various features of the present invention.

Accordingly, a method is provided for communication between a server and a client, comprising the steps of: embedding in a multimedia medium a communication module, the multimedia medium having a stored music program; distributing the audiovisual medium to the user; and installing in a computer the communication module upon playback of the music program stored in the audiovisual medium by the computer, the communication module having stored codes executable by the computer to establish a communication link with the server.

Preferably, the communication module includes a browser for facilitating communication between the server and the user, and the server directs communications to the user through the browser. The communication link between the server and the user is preferably via TCP/IP.

In a preferred embodiment, the communication module includes codes for causing the computer to monitor usage in connection with the window by the user, and forwarding the usage information to the server.

Many Internet sites, such as Yahoo, MSNBC, Digital Impact, Click Action and Netcentives provide users with personalized services ranging from e-mail to customized home pages. In all such cases, users are providing these companies with fairly comprehensive personal information that can allow them to design the kind of highly personalized direct marketing programs that have been proven to be successful. Because the kind of information that is directed towards users is pre-determined and permission-based, the users are more comfortable with the marketing campaigns that are directed at them and feel that it is a small price to pay for a highly desired service. The greater level of comfort generally leads to a greater willingness to at least pay some attention to the marketing message and hence, in aggregate, a greater success rate in terms of the actual purchase of products and/or services. Since the information is compiled and distributed electronically, the cost to deliver these marketing campaigns is significantly lower than postal mail, print, television, or any other non-computer based medium.

The exact nature of this invention, including the above-described and other features, singly and in combination, will be apparent from the following detailed description, the attached claims, and the drawings.

### BRIEF DESCRIPTION OF THE DRAWINGS

FIG. 1 illustrates the architecture of a communication system according to the present invention.

FIG. 2 is a diagram of software functions and applications on the client side of the communications system.

FIG. 3 is the diagram of the software functions on the server side of the communications system.

FIG. 4 is block flow diagram showing the functionality of a method and system according to the present invention.

FIG. 5 is an example welcoming screen presented to a user the first time he or she accesses the server side of the system after installation.

FIG. 6 is a sample registration screen.

FIG. 7 is a sample personal e-messenger user interface for displaying targeted messages to the user.

### DETAILED DESCRIPTION OF EMBODIMENTS OF THE INVENTION

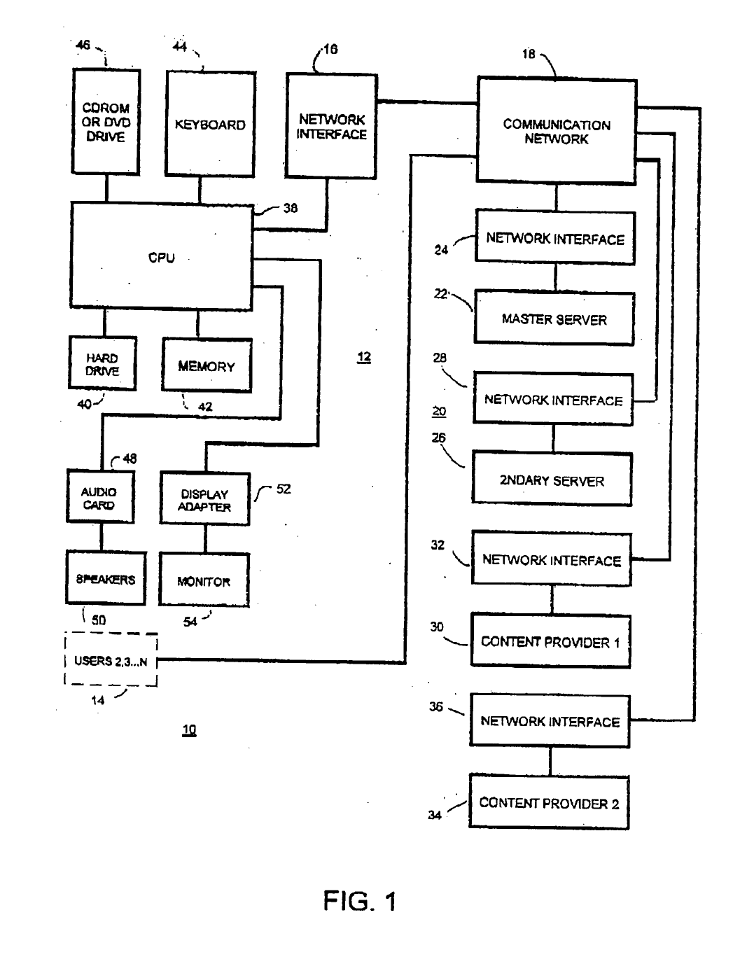

A system suitable for practice of the present invention is illustrated in FIG. 1. This is constructed on a client-server model. The client side, generally denoted at 10, is comprised of a first user installation 12 and one or more additional user installations generally denoted at 14. User installation 12 includes a network interface unit 16 such as a modem, by which the user's computer is connected to the communication network 18. The additional user installations 14 similarly include network interfaces (not shown) for connection to communication network 18.

The server side of the system, generally denoted at 20, is comprised of a master server 22 connected to communication network 18 through a network interface 24, a secondary server 26 connected to communication network 18 through a network interface 28, a first content provider installation 30 connected to the communication network through a network interface 32 and a second content provider installation 34 connected to the network through a network interface 36. It should be understood, however, that server side 20 is illustrated in simplified form and that the respective servers and network interfaces are components of complete server installations including facilities for providing various functions as described herein. In addition, it should be understood that for purposes of illustration, only one secondary server installation and two content provider installations are shown. In general, additional secondary server installations may be provided and there will be more than two content provider installations.

Returning to the architecture of user installation 12, it will be assumed for purposes of description that this is a personal computer of any conventional or desired type and includes a central processing unit 38, suitable storage such as a hard drive 40, memory 42, input devices such as keyboard 44 and CD-ROM or DVD drive 46, an audio card and associated loud speakers 50, and a video display adapter 52 and associated monitor 54. The architecture of other user installations 14 may be the same as that of user installation 12. The invention is intended for use on computers running any suitable operations such as the Microsoft® Windows® or Macintosh® operating systems.

Referring again to server side 20, master server 22 and secondary server 26 may be of similar physical construction. Generally speaking, profile information about the universe of users and the information generated by the content providers is duplicated on master server 22 and secondary server 26, but master server 22 preferably also provides routing functions for traffic management, synchronization of user information and provider content on all servers, software updates for the user installations and transmission of other information necessary to ensure proper functioning of the system.

Servers 22 and 26, and respective network interfaces 24 and 28 may be personal computers running the Microsoft® Windows® NT operating system, or other desired operating system, and including customary data storage and other peripheral equipment typically employed in server installations.

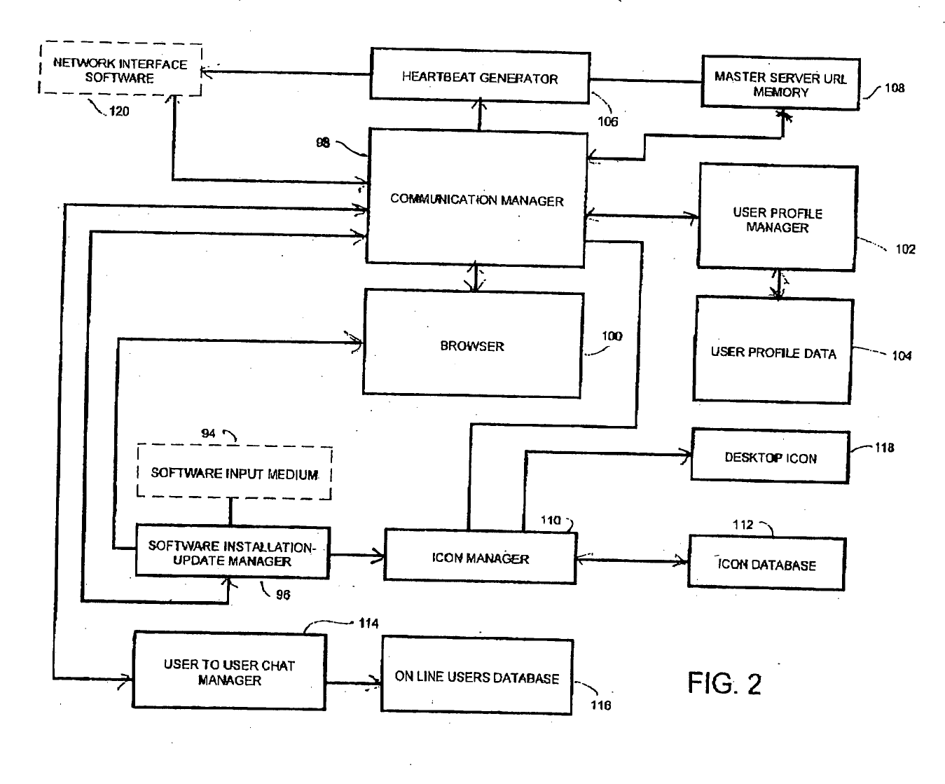

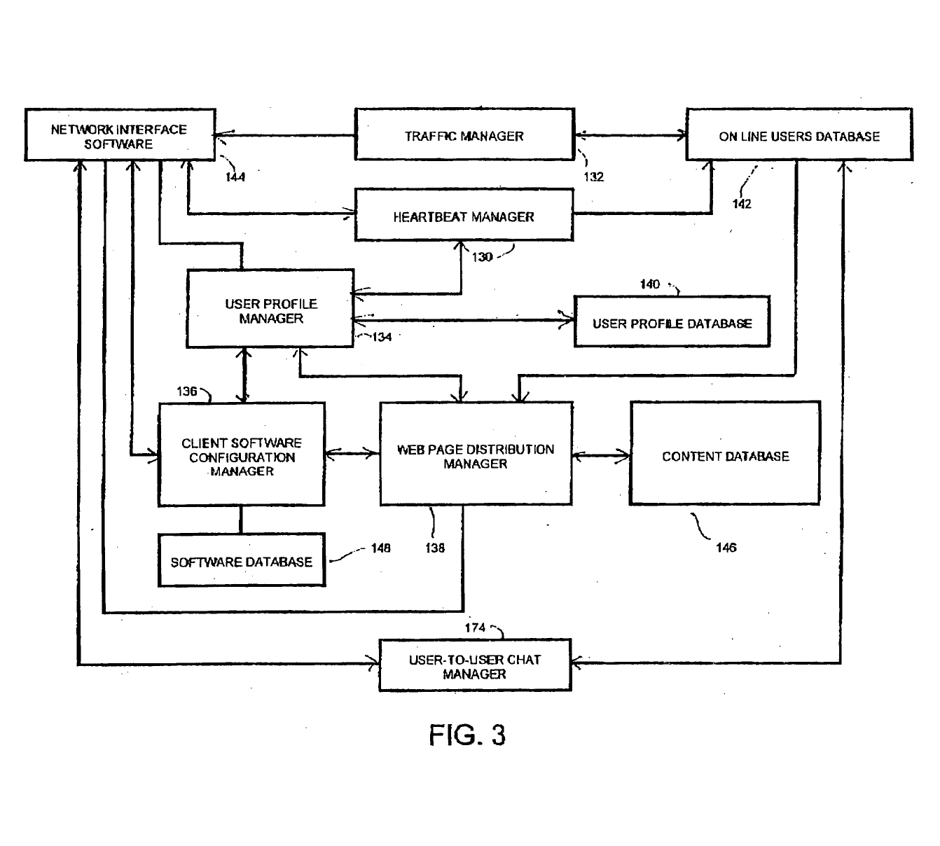

The software functions associated with client side 10 and server side 20 of the system are illustrated respectively in FIGS. 2 and 3, in which it will be understood that the arrowheads on the connecting lines indicate information and control flow. In this connection, it should also be understood that the actual software implementation may be accomplished within the scope of this invention in a variety of ways using conventional object oriented programming techniques and commercially available programming languages such as Hypertext Markup Language (HTML), Extensible Markup Language (XML), Javascript, Java, C⁺⁺, etc. The required database functions can be implemented using any commercially available database management system such as Microsoft SQL Server.

Referring now to FIG. 2, as previously mentioned, and according to a preferred embodiment of the present invention, the software is preferably distributed to the user as an adjunct to the entertainment or information content of a multi-media product such as a music CD or DVD (shown in outline at 94). The entertainment content of the CD or DVD preferably includes a music program such as a popular song of a known artist. The CD or DVD can be played using a traditional CD or DVD player. The content may include a video which is displayed as the song is played over speakers. Upon access of the entertainment content of the CD or DVD by a computer, the embedded software installs the communication module in that computer. The software includes an installation-update manager 96, a communication manager 98, a browser 100, a user profile manager 102 and associated user profile data 104, an online presence identification or “heartbeat” generator 106, and an icon manager 110 and associated icon database 112.

Software installation-update manager 96 controls installation of the comm module from input medium 94 to the user's computer. This software component functions as a setup program to create a folder on the user's hard drive 40 (see FIG. 1), to load itself and the other components of the comm module into that folder and to prompt the user as necessary to set preferences for display, message notification and other options. Then, the functions of the icon manager 110 are invoked to place an icon representing the entertainment or other information content of the distribution medium 94 on the user's desktop. This may be placed, for example, in the system tray on a computer running Windows 95 or Windows 98, or directly on the desktop if the computer is running a Macintosh operating system. Specific software code required to accomplish the functions described above will depend on the particular operating system, and the creation of actual codes to implement the functions of the invention should be readily apparent to one ordinarily skilled in the art based on the disclosure of the present invention.

Installation manager 96 completes the installation process by making any necessary changes in various system files (such as the registry files used by the Microsoft Windows 95 and 98 operating systems), and then gives the user the option to immediately log on to the server side of the system through network interface 16 and communication network 18 (see FIG. 1).

The operations involved in an online session are controlled by communications manager 98. This is preferably a command processor programmed to initiate online communication when the user clicks on desktop icon 118, and to operate heartbeat generator 106 to transmit the heartbeat signal indicating the user's presence online to master server 22. For this purpose, the specific Internet address (URL) of the master server 22 is hard coded in master server URL memory 108.

Communication manager 98 also provides control over the operation of browser 100. In accordance with this invention, the functions of browser 100 may be accomplished by the use of an existing commercially available product such as the Microsoft Internet Explorer® or the Netscape Navigator®. However, to avoid potential incompatibility issues, it is preferred to employ a dedicated “light” browser created to provide the specific functions required for optimum access to the information stored on the server side of the system. The features provided may include viewers for advanced multimedia effects to provide the maximum possible enhancement of the user's online experience. Although user profile information is created on Web pages and is managed and stored on the server side of the system, user profile data 104 may also be stored locally, for example, to permit automated log-on for access to confidential information. For convenience, the user profile manager 102 is shown separate from communication manager 98, but the profile management functions may alternatively be included as part of the command processor functions of communication manager 98.

The software functions associated with master server 22 (see FIG. 1) are illustrated in FIG. 3. These functions include heartbeat manager 130, traffic manager 132, user profile database manager 134, client software configuration manager 136 and Web page distribution manager 138, all of which provide command processor functionality to control the storage and delivery of information to and from the comm modules, and the various content providers such as 30 and 34 shown in FIG. 1.

Heartbeat manager 130 responds to incoming heartbeat signals to identify which users are online at a given time. When heartbeat manager 130 detects an incoming heartbeat signal it accesses the user profile database 140 through user profile database manager 134 to determine the identity of the user, and updates a list of users online stored in online users database 142. Preferably, once a user is identified and communication is established between master server 22 and user 14, all activities of that user (in real time) are monitored by components of the master server 22. Traffic manager 132 accesses the information in the online users database 142 and estimates the volume of traffic. It then determines the optimum distribution of traffic and sends commands through communication network 18 (by means of network interface software 144) to each comm module which is then on line including the URL of the specific server in the system with which to conduct further communication. It also updates traffic and user distribution information stored on secondary server 26 and any other secondary servers on the system.

User profile database manager 134 and associated user profile database 140 manage and store demographic information for each of the users who have provided profile information. Comm module configuration information (e.g. version number) may be stored as well. Profile information is generated when a user fills in blanks on a series of profile inquiry Web pages displayed by the user's browser.

Client software configuration manager 136 and associated software database 148 are both responsible for ensuring that the most current version of the comm module has been downloaded to each user. Updated user software created by the proprietor of the server side of the system is stored in software database 148. When heartbeat manager 138 recognizes that a user has logged on to the master server 22, configuration manager 136 is called to access user profile database 140 to identify the user's version of the comm module. If software modifications have been made since the last update of the user's software, the current version of the software is downloaded to that user, and the functions of the software installation update manager 96 (see FIG. 2) are invoked to update the user's comm module.

Alternatively, it is not necessary to include version information for each user in the user profile database 140. Instead, software configuration manager 138 may simply query each user as it logs on to the server to determine the version of its software and to initiate a download of an updated version if necessary.

Content database 146 is the repository of the information intended for delivery to the users. Stored information is catalogued according to predefined properties correlated with the various elements of the user profiles. For example, content data may be categorized as information about a particular artist, a particular type of music, a particular category of news (e.g., world news, sports news, etc.), or even personal information such as frequent flier mileage for specific system users.

Whenever a particular user logs onto the server for the first time, distribution manager 138 provides the user access to a gateway page inviting creation of a profile of that user. If user profile manager 134 recognizes the user logging on as one who has already created a profile, access is provided to a “members only” home page from which additional information can be viewed by clicking on HTML hot links in a conventional manner. If the user has established more than one profile, each will be associated with a separate icon on his or her desktop and with a separate heartbeat. When the user clicks on the icon corresponding to his interest at that time, the identifying heartbeat associated with that icon is transmitted, and the gateway or member page is invoked corresponding to the user's icon selection.

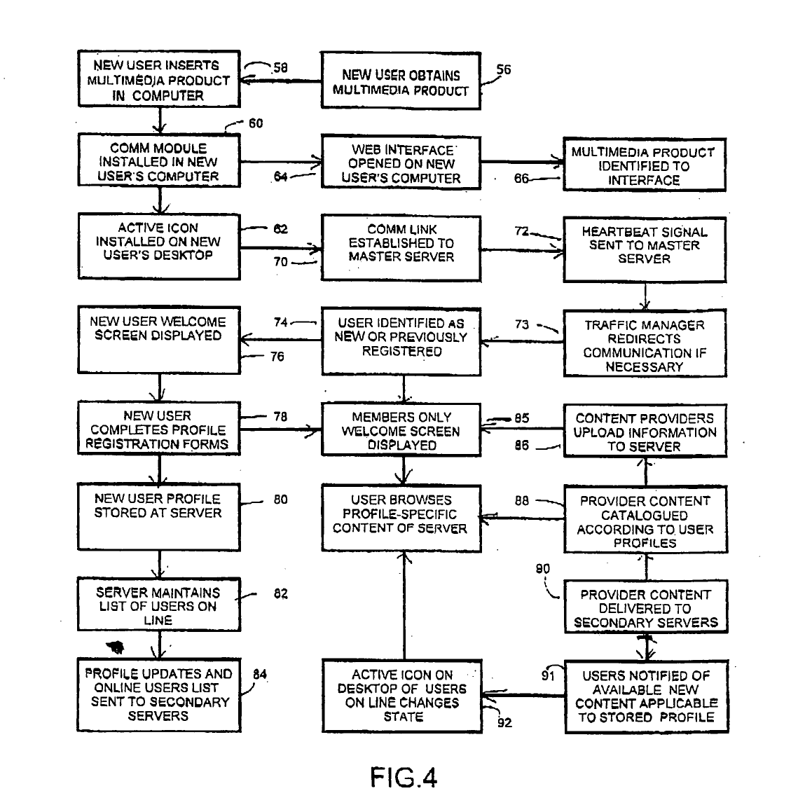

The overall functionality of the software as described above is illustrated in block flow diagram form in FIG. 4. The process begins at step 56 when a new user acquires a multimedia product containing the comm module in addition to its entertainment or other information content. As suggested above, the multimedia product may be acquired in various ways including direct retail purchase, complimentary mass distribution of product samplers, etc. Another way in which the software may be distributed is by inclusion in an entertainment product created online by individual users and then delivered in the form of the CD ROM for DVD.

At step 58, the user places the multimedia product in his or her CD ROM or DVD drive 46 (see FIG. 1). Software installation manager 96 then installs the comm module, including Web browser 100 along with available multimedia viewers (step 60). Installation manager 96 then installs an active icon on the user's desktop at step 62, opens Web browser 100 at step 64, and identifies the multimedia product itself to the browser at step 66. At step 70, the user's network interface software 120 (see FIG. 2) is invoked to establish a connection to master server 22 (see FIG. 3) at the URL hand coded in URL memory 108 (see FIG. 2). The comm module then transmits the heartbeat signal to the server (step 72). Traffic manager 132 (see FIG. 3) determines whether to adjust traffic on the system, and if necessary, sends a command containing the URL of the server with which further communication is to take place (step 73).

The heartbeat signal is then analyzed, and identified as that of a new user or a previously registered user (step 74). If this is the first use of the multimedia product on the user's computer, a new user welcoming screen is presented by browser 100 and the user is invited to register (step 76). If the user accepts the invitation, he or she is prompted to complete a series of Web page forms on which the user provides information which will form his or her profile (step 78). After the user has completed the registration process, at step 80, the user's profile is stored on the server in user profile database 140 (FIG. 3). Then the user online list is updated (step 82) and the new information is transmitted to the other servers to update their profile databases and online lists (step 84). If the user is identified as previously registered, a “members only” welcoming screen is displayed and only the list of users on line is updated (step 85). The “members only” screen is also displayed for new users when the registration process has been completed.

Content to be made accessible to the users is uploaded to the master server by the various content providers at step 86. It is then organized according to the various user profiles at step 88 and distributed to secondary server 26 at step 90 (see FIG. 1).

When a user is online, as indicated by the presence of the heartbeat signal associated with his or her comm module, master server 22 determines if there is new content not already viewed by that user. If so, master server 22 sends a notification to that user's comm module over the communication network (step 91). When the notification is received, the comm module responds by changing the state of the user's desktop icon, and by providing an audible indication, if the user has selected this as an option (step 92). Then, at step 94, the user may browse the content on the server associated with his or her stored profile.

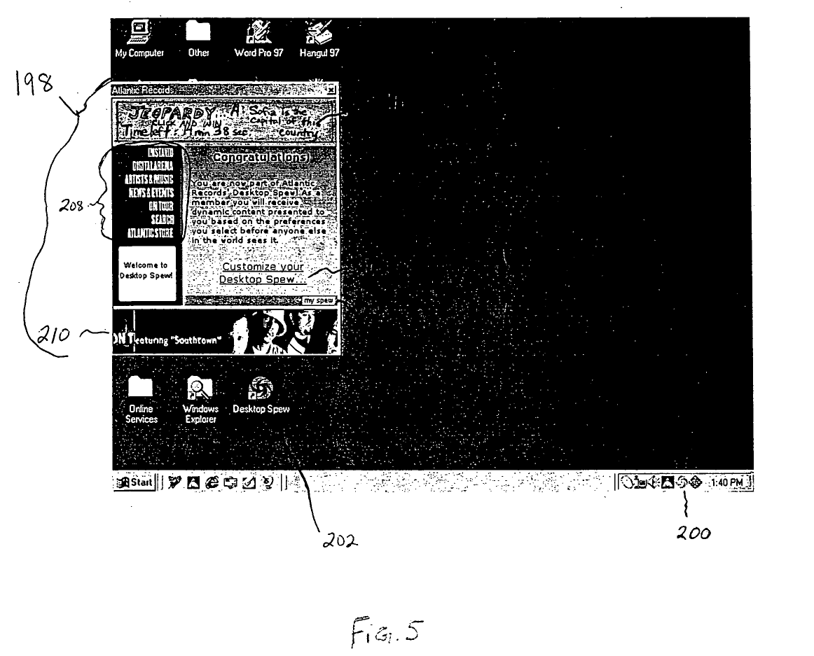

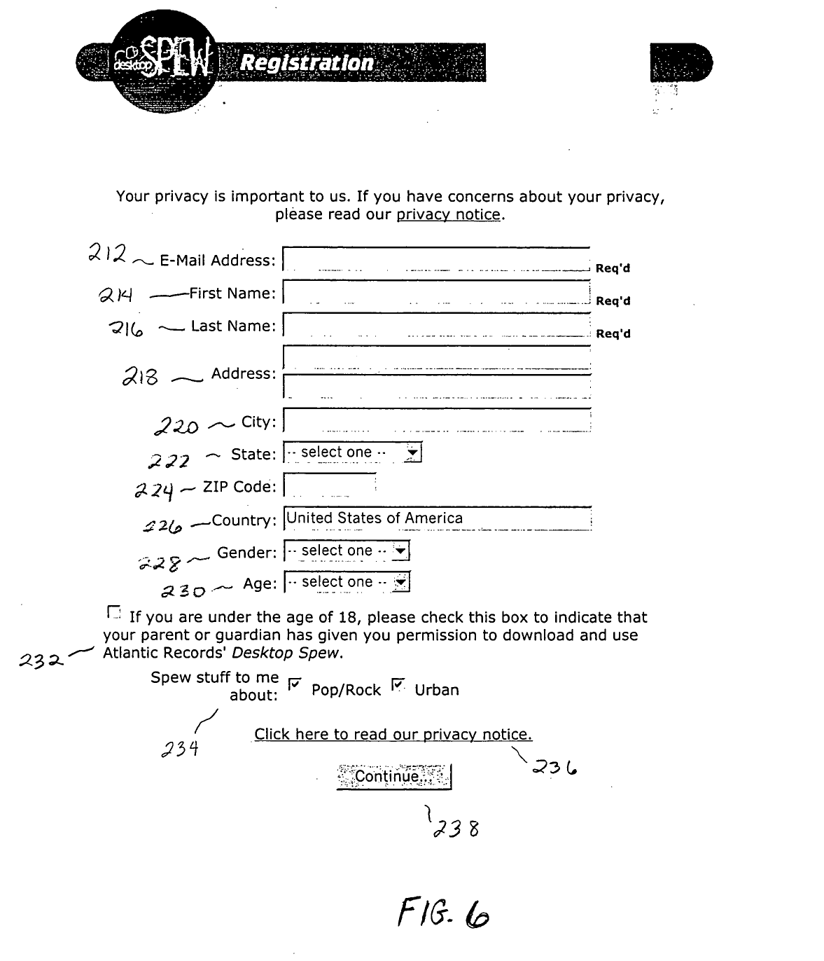

In another example of a preferred embodiment as a matter of illustration, and not by way of limitation, FIG. 5 illustrates a welcoming screen comprising a Desktop Spew icon 202, which indicates that the icon is also in the taskbar (200). When clicked on, the taskbar icon 200 brings up a graphic user interface 198, which is a conventional HTML document (in this case, an Atlantic Records site) and includes a live link 204 consisting of the words, “Customize your Desktop Spew”. If the user accesses this link, a registration screen such as that illustrated in FIG. 6 is presented. Here, the user fills in the required elements of his first and last name and E-mail address (lines 212-216), and optional information such as his home address, city, state, zip code, country, gender and age (lines 218-230). When a user fills in this information, a user profile is generated, and the profile is then used to customize any information the user receives so that such information pertains to that particular user's interests, age group, etc. This is advantageous in reducing irrelevant and unwanted messages being sent to a user, therefore resulting in a greater advertising success rate by targeting specific users with information tailored to their individual interests and demographic information.

The registration screen also contains a check-off box 232, which users under the age of 18 are to click on to indicate that parental or guardian permission to download Desktop Spew has been granted. The user can indicate his music preference at 234, and a live link 236 is provided to access a privacy notice discussing online security. The user signifies completion of the information by clicking on “Continue . . . ” link 238.

Following registration, the icon 200 in FIG. 5 will flash to indicate when the user has received new messages pertaining to his profile. This not only alerts the user to relevant information tailored to that person's interests, but does so in an unobtrusive way which is personalized (as opposed to sending unsolicited and random E-mail messages). In addition, the user has the option of choosing whether or not to click on the icon to access the new information, thus it gives the user the choice of accessing such information whenever it is convenient for him to do so.

FIG. 5 also presents an ad banner 210 which is an HTML document and links the user to a page describing the ad in more detail. This ad banner is an eye-catching way of advertising and grabbing a user's attention while the user is accessing a site, while at the same time not being unduly intrusive. If the user chooses to find out more about the advertisement, he can do so by clicking on the ad banner whenever he wishes.

The graphic user interface 198 in FIG. 5 also contains live link 206 comprising the words “my spew” which links the user back to the registration screen FIG. 6, thus enabling the user to make any desired changes to his profile. This live link on the graphic user interface 198 makes it easy to update one's profile whenever the user desires.

Banner 211 of FIG. 5 serves as an interaction/advertisement area wherein a banner designed for user attraction and interaction is placed. The banner can be in the form of another advertisement from another content provider or advertiser, or preferably, the banner is a streaming video attraction such as a video game or a quiz question involving user interaction. As shown in FIG. 5, banner 211 features the trivia-type game ‘Jeopardy.’ To provide an incentive for a user to interact, a prize is awarded if the user clicks on the banner and provides a correct answer within a certain period of time, for example within 5 minutes. The award can be a credit or point which the user can accumulate for use as award points or money toward purchases on sites hyperlinked to sponsors of the server.

The interface 198 in FIG. 5 also illustrates a set of live links (208), comprising a menu of channels organized according to content which the user can access anytime by selectively clicking on the desired channel. This menu reduces desktop clutter since it reduces the presence of numerous icons on the desktop, and instead organizes them into a plurality of individual channels according to subject matter. In one example of a preferred embodiment there exists the following seven channels: “Instavid”, “Digital Arena”, Artists & Music”, News & Events”, “On Tour”, “Search”, and “Atlantic Store”.

Exemplary presentations from the selection of channels include: a screen comprising live links which connect the user to various video clips (Instavid); a screen which contains live links to a past event section, a home page, an artist interview section, various albums or movies which include audio and video clips for the user to sample, and a link which lists upcoming events (Digital Arena); a screen which allows the user to search for a specific artist or title by providing specific information, a navigation bar which allows the user to link to various other channels without having to go back to the graphic user interface box, a billboard ad, an icon linking the user to a home page and a banner ad (Artists & Music).

Other channels more tailored to the sponsoring provider can similarly be presented to the user for easy access and hyperlinking. Preferably, each sponsor presents a ‘store’ channel for selection and electronic shopping by the user of the goods and services offered by the sponsor. By selecting the “Store” channel, a screen is produced having some of the same features mentioned above such as a banner ad and a home page link; it also includes an icon entitled “Pick of the Day”, a list of separate shopping categories, a live link to an online security site, a group of album billboards categorized according to status, and a set of links directed towards customer service. The screen also contains a search engine allowing the user to conduct a search based on genre, a keyword, or alphabetically. Upon entering this information, the user then clicks on a hyperlink to initiate the search.

An additional feature of the system is illustrated in FIGS. 2 and 3. This feature is an instant messaging capability between users logged onto the system. This functionality is provided by means of a user to user chat manager 174 in association with online users database 142 (see FIG. 3). Chat manager 174 periodically transmits information to each user identifying those users presently online. This information is detected at each comm module by user to user chat manager 114 and stored in the local online users database 116.

Another feature of the system illustrated in FIGS. 2 and 3 is the real-time user profiling capability. This capability is provided by user profile manager 134, user profile database 140, and heartbeat manager 130. Upon notification from heartbeat manager 130 that a user is online, the profile manager 134 monitors each action (or click) performed by the user while the communication link between main server 20 and user 14 is maintained. The actions of the user that are monitored include the paths of traverse by the user. Preferably, each traverse is time stamped by user profile manager 134 for tracking ‘where the user went and for how long.’ This process is performed as the information gathered is stored in user profile database 140 for subsequent processing and analysis.

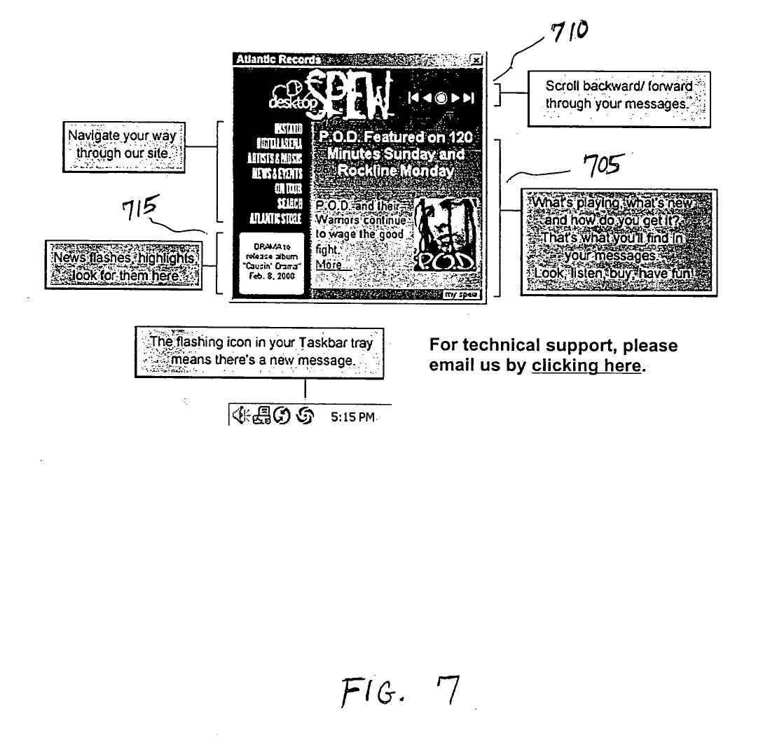

As a matter of illustration and not by way of limitation, FIG. 7 is an example of a personal e-messenger user interface which will appear after the user enters the required information in the registration screen (FIG. 6) and clicks on the Desktop Spew icon 200. This interface is an example featuring Atlantic Records and includes a message box 705 for displaying incoming messages targeted towards the user according to information collected from the user. A scrolling tool 710 allows the user to scroll forwards or backwards through the messages. The messages will flash across message box 705 in response to the user's scroll selection. The message box 705 contains a link which the user can click on if he wants to access a more detailed version of the message. In addition, the user interface also contains a live link 715 displaying news flashes and highlights. The user can click on the highlight or headline that interests him to find out about that particular article in more detail.

A key advantage of the present invention is the use of the direct linkage between the central server 20 and user 14 upon the user accessing the Internet. This feature differs from the traditional profiling and communication techniques to attract or reach a user or potential customer. In traditional web-based profiling and communication methods, when a user opens his browser 100 to access the Internet, the user's browser generates an HTTP message to get the information for the desired web page. The web site in response to the HTTP message transmits one or more messages back containing the information to be displayed by the user's browser. In some cases an advertising server provides additional information including objects such as banner advertisements to be displayed with the information provided from the web site. Typically, the computers supporting the browser, the web site and the advertising server are different nodes on the Internet. Upon clicking through or otherwise selecting the advertisement object, which may be an image such as an advertisement banner, an icon or a video or an audio clip, the user's browser is hyperlinked to the advertiser's web site for that advertisement object. Typically, the web-site server or the advertising server retrieves information from: (i) the user's IP address, (ii) a cookie if the browser is cookie enabled and stores cookie information, (iii) a substring key indicating the page in which the advertisement to be provided from the server is to be embedded, and (iv) MIME header information indicating the browser type and version, the operating system of the computer on which the browser is operating and the proxy server type. Upon receiving the request in the message, the advertising server determines which advertisement or other object to provide to the user's browser and transmits the messages containing the object such as a banner advertisement to the user's browser using the HTTP protocol. Preferably contained within the HTTP message is a unique identifier for the advertiser's web page appropriate for the advertisement. That advertisement object is then displayed on the image created by the user's browser as a composite of the web page plus the object transmitted back by the advertising web server.

When the user clicks on the banner or other advertising object displayed by the user's browser, the user's browser again transmits a message to the ad server. The ad server notes the address of the computer of the browser (as identified above) that generated the message and transmits back the URL of the advertiser's web page so that the user's browser generates a message to contact the advertiser's web site. It is readily apparent to one ordinarily skilled in the art that the direct linkage profiling and communicating method according to the present invention is advantageous over the above illustrated traditional web-based profiling method because the users of the present invention are already targeted users and more pertinent data on the user can be gathered due to the real-time and direct linked nature of the present invention.

Advantageously, the preferred features of the present invention, including targeted distribution of embedded ‘comm module’ media, featured interaction attractions presented to users online for interaction, and real-time monitoring of user online activities, all operate to yield increased interaction by targeted users with the website, which in turn results in increased commercial activities or transactions through the website.

Having described preferred embodiments of a system and method for disseminating information over a communication network based on predefined consumer profiles according to the present invention, it is noted that modifications and variations can be made by persons ordinarily skilled in the art in light of the above teachings Numerous modifications and variations of the present invention are possible in light of the above teachings. It is therefore to be understood that, within the scope of the appended claims, the present invention can be practiced in a manner other than as specifically described herein.

1. A method of communication between a server and a client, comprising the steps of:
embedding in a multimedia medium a communication module, said multimedia medium having a stored music program;
distributing said audiovisual medium to the user; and
installing in a computer the communication module upon playback of the music program stored in the multimedia medium by the computer, said communication module having stored codes executable by the computer to establish a communication link with the server.

2. The method of claim 1, wherein said step of installing includes installation of a browser for facilitating communication between the server and the user.

3. The method of claim 2, wherein the server directs communications to the user through the browser.

4. The method of claim 1, wherein said communication link between the server and the user is via TCP/IP.

5. The method of claim 4 wherein the communication module includes codes for causing the computer to direct a message to the server upon detection of transmission of TCP/IP data from the computer.

6. The method of claim 1, wherein said step of installing the communication modules includes installation of a linking icon displayed on one of a task bar tray and a desktop of the computer.

7. The method of claim 6, wherein a pop-up window is displayed upon selection of said icon by the user.

8. The method of claim 7, wherein the communication module includes codes for causing the computer to monitor usage of the window by the user.

9. The method of claim 7, wherein the communication module causes the computer to forward to the server data representing the usage of the window by the user.

10. The method of claim 6, wherein the communication module includes codes for causing the icon to flash upon receipt of a message from the server.

11. The method according to claim 1, wherein said multimedia medium is one of a compact disk (CD) and a DVD.

12. A method for linking a server to a user over a communication network, comprising the steps of:
distributing a communication module to a user for installation at a computer of the user;
providing a desktop icon and a browser in the computer of the user upon installation of the communication module;
connecting the user to the server via the browser when the desktop icon is selected by the user;
accessing a database on the server side to provide the server with information on the user; and
communicating between the server and the user in real-time via the browser during the user's online session.

13. The method of claim 12, wherein said step of distributing includes embedding the communication module in a multimedia medium, said multimedia medium includes stored entertainment content.

14. The method of claim 13, wherein the communication module is automatically installed on the user's computer when the entertainment content of the multimedia medium is accessed by the user.

15. The method of claim 12, wherein said step of distributing includes downloading the communication module from a website provided by the server.

16. The method of claim 12, wherein said browser presents a pop-up-window upon selection of the icon.

17. The method of claim 16, wherein said window includes hyperlinking content provided by the server and by a sponsor.

18. The method of claim 16, wherein the window includes a profiling icon which, when accessed, presents a series of profile inquiry pages to develop a user profile.

19. The method of claim 12, wherein the desktop icon changes state to alert the user that the server has a message for the user.

20. The method of claim 12, wherein the communication module sends a message to the server at a predetermined Internet address when the user establishes connection to the communication network.

21. The method of claim 16, further including the step of monitoring all user actions in connection with the window in real time.

22. The method of claim 21, further including the step of storing information on the user gathered from the step of monitoring in a database at a location specific to the user.

23. The method of claim 16, wherein the window includes interactive content for facilitating interaction by the user with the server.

24. The method of claim 23, wherein the interactive content is a quiz which when accessed and a correct answer is provided within a predetermined time, provides an award to the user.

25. The method of claim 24, wherein the user is awarded with credits for use toward purchases on sites hyperlinked to sponsors of the server.

26. A multimedia medium having stored codes readable by a computer for executing method steps for installing a communication module in the computer, said multimedia medium further including entertainment content presentable from the computer, the method comprising:
installing the communication module in the computer upon presentation of said entertainment content by the computer;
placing an icon on the desktop of the computer upon installation of the communication module; and
communicating with a server at an URL address stored in said multimedia medium upon access of said icon by a user of the computer.
